(19) United States
(12) Patent Application Publication
(10) Pub. No.: US 2026/0300632 A1
(43) Pub. Date: Oct. 1, 2026

(54) INFORMATION PROCESSING APPARATUS, SUPPORT METHOD, AND NON-TRANSITORY RECORDING MEDIUM

(71) Applicant: NEC Corporation, Tokyo (JP)

(72) Inventors: Shin NORIEDA, Tokyo (JP); Hisaya WAKAYAMA, Tokyo (JP); Kenichi TAKIGUCHI, Tokyo (JP); Chisho UEDA, Tokyo (JP); Yuto TSUKADA, Tokyo (JP)

(73) Assignee: NEC Corporation, Tokyo (JP)

(21) Appl. No.: 19/569,071

(22) Filed: Mar. 17, 2026

(30) Foreign Application Priority Data
Mar. 28, 2025 (JP) 2025-056853

(51) Int. Cl. G06F 40/30

(52) U.S. Cl. CPC G06F 40/30

(57) ABSTRACT

An information processing device includes a selection unit for selecting at least one persona based on at least one of a content of target content that is content to be checked, a creating entity, a presentation target, and an application, and a check unit for checking the target content from a viewpoint of the persona selected by the selection unit. Furthermore, according to the information processing device, creation work of the target content can be optimized.

### INCORPORATION BY REFERENCE

This application is based upon and claims the benefit of priority from Japanese patent application No. 2025-056853, filed on Mar. 28, 2025, the disclosure of which is incorporated herein in its entirety by reference.

### TECHNICAL FIELD

The present disclosure relates to an information processing apparatus, a support method, and a non-transitory recording medium.

### BACKGROUND ART

Techniques for supporting creation of materials have been known. For example, WO 2021/261132 A1 below discloses a determination device that estimates an insufficient matter from a formal viewpoint related to whether predetermined information is described in the material and estimates an insufficient matter from an implicit viewpoint related to a configuration of the material. It is possible to automatically check the material by using this determination device. Therefore, it can be said that the determination device described in WO 2021/261132 A1 can contribute to improving the efficiency of creating materials.

### SUMMARY

In the determination device described in WO 2021/261132 A1, materials are checked using check item data indicating check items of a check person such as a customer or a boss. This checking method has room for improvement in that the viewpoint of checking is fixed. For example, in the determination device described in WO 2021/261132 A1, even in a case where materials to be used only in the company are to be checked, a check result regarding check items of a customer is reflected. That is, in this case, since the check item does not match the application of the material, the check accuracy may be deteriorated.

As described above, the determination device described in WO 2021/261132 A1 has room for improvement in that the viewpoint of checking is fixed. This is a point that improvement is commonly desired not only in the check of the material but also in the check of arbitrary content. An example object of the present disclosure is to provide a technique that enables content to be checked from a reasonable viewpoint.

An information processing device according to an example aspect of the present disclosure includes a selection means for selecting at least one persona based on at least one of a content of target content that is content to be checked, a creating entity, a presentation target, and an application, and a check means for checking the target content from a viewpoint of the persona selected by the selection means.

In a support method according to an example aspect of the present disclosure, at least one processor executes selection processing of selecting at least one persona based on at least one of a content of target content that is content to be checked, a creating entity, a presentation target, and an application, and check processing of checking the target content from a viewpoint of the persona selected by the selection processing.

A support program according to an example aspect of the present disclosure causes a computer to function as a selection means for selecting at least one persona based on at least one of a content of a target content that is a content to be checked, a creating entity, a presentation target, and an application, and a check means for checking the target content from a viewpoint of the persona selected by the selection means.

According to an example aspect of the present disclosure, there is an exemplary effect that a technique that enables content to be checked from a reasonable viewpoint can be provided.

### BRIEF DESCRIPTION OF THE DRAWINGS

FIG. 1 is a block diagram illustrating a configuration of an information processing device according to the present disclosure;

FIG. 2 is a flowchart illustrating a flow of a support method according to the present disclosure;

FIG. 3 is a block diagram illustrating a configuration of another information processing device according to the present disclosure;

FIG. 4 is a diagram illustrating a display screen example at the time of collecting material data of a target content in a chat format;

FIG. 5 is a diagram illustrating a display screen example of a check result;

FIG. 6 is a flowchart illustrating a flow of processing executed by the information processing device illustrated in FIG. 3; and

FIG. 7 is a block diagram illustrating a configuration of a computer that functions as the information processing device according to the present disclosure.

### EXAMPLE EMBODIMENT

Hereinafter, example embodiments of the present invention will be described. However, the present invention is not limited to the following exemplary example embodiments, and various modifications can be made within a scope described in the claims. For example, example embodiments obtained by appropriately combining techniques (some or all of things or methods) adopted in the following exemplary example embodiments can also be included in the scope of the present invention. Example embodiments obtained by appropriately omitting some of the techniques adopted in the following exemplary example embodiments can also be included in the scope of the present invention. Effects mentioned in the following exemplary example embodiments are examples of effects expected in the exemplary example embodiments, and do not define extension of the present invention. That is, example embodiments that do not achieve the effects mentioned in each of the exemplary example embodiments described below can also be included in the scope of the present invention.

### First Exemplary Example Embodiment

A first exemplary example embodiment that is an example of the example embodiments of the present invention will be described in detail with reference to the drawings. The present exemplary example embodiment is a basic form of each exemplary example embodiment to be described later. An application range of each technique adopted in the present exemplary example embodiment is not limited to the present exemplary example embodiment. That is, each technique adopted in the present exemplary example embodiment can also be adopted in other exemplary example embodiments included in the present disclosure within a range in which no particular technical problem occurs. Furthermore, each technology illustrated in the drawings referred to for describing the present exemplary example embodiment can also be adopted in other exemplary example embodiments included in the present disclosure within a range in which no particular technical problem occurs.

### Configuration of Information Processing Device 1

A configuration of an information processing device 1 according to the present exemplary example embodiment will be described with reference to FIG. 1. FIG. 1 is a block diagram illustrating the configuration of the information processing device 1. As illustrated in FIG. 1, the information processing device 1 includes a selection unit 101 and a check unit 102.

The selection unit 101 selects at least one persona based on at least one of the content of the target content that is the content to be checked, the creating entity, the presentation target, and the application.

Here, “check” means to confirm the contents, and can be rephrased as “confirm”, “evaluate”, “inspect”, and the like. In addition, “persona” means a person image set as a checker of the target content. The “persona” can also be rephrased as, for example, a “character”. The person image represented by the persona may be based on a real person, or may be a virtual image not based on a real person. Furthermore, the “target content” may be any content that can be the target of a check. For example, the content may include at least one of text data, image data, and voice data.

Furthermore, selecting the persona “based on” the content of the target content or the like means directly or indirectly using the content of the target content or the like in the selection of the persona.

For example, the selection of the persona using the result of analyzing the content of the target content or the like can also be said to be the selection of the persona based on the content of the target content or the like.

The check unit 102 checks the target content from the viewpoint of the persona selected by the selection unit 101. In other words, check unit 102 checks the target content such that the persona selected by selection unit 101 is reflected in the check result. Although details will be described in the second exemplary example embodiment, various methods can be applied as a method for reflecting a persona in the check result.

As described above, the information processing device 1 according to the present exemplary example embodiment adopts a configuration including the selection unit 101 for selecting at least one persona based on at least one of the content of the target content that is the content to be checked, the creating entity, the presentation target, and the application, and the check unit 102 for checking the target content from the viewpoint of the persona selected by the selection unit 101.

According to the above configuration, the target content is checked from the viewpoint of the persona selected based on at least one of the content, the creating entity, the presentation target, and the application of the target content. Therefore, according to the information processing device 1, an effect that the content can be checked from a reasonable viewpoint can be obtained. Furthermore, according to the information processing device 1, creation work of the target content can be optimized.

### Support Program

The functions of the information processing device 1 described above can also be achieved by a program. A support program according to the present exemplary example embodiment causes a computer to function as a selection means for selecting at least one persona based on at least one of the content of the target content that is the content to be checked, the creating entity, the presentation target, and the application, and the check means for checking the target content from the viewpoint of the persona selected by the selection means. According to this support program, an effect that the content can be checked from a reasonable viewpoint can be obtained.

### Flow of Support Method

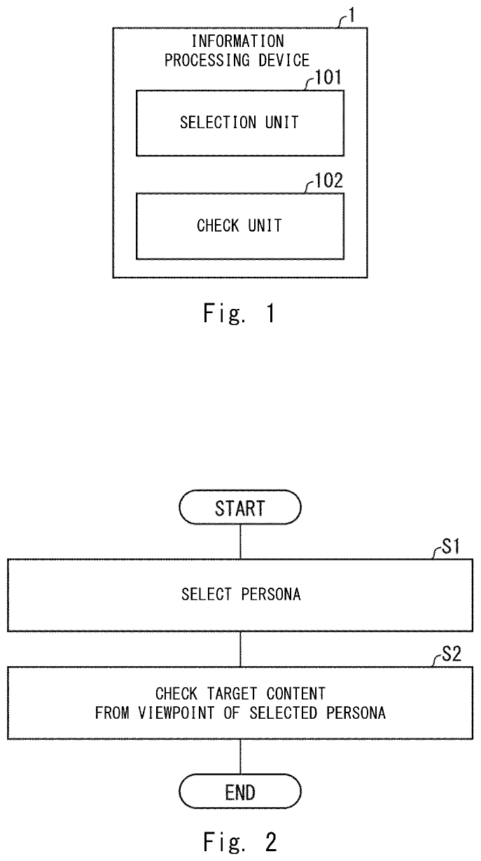

A flow of a support method according to the present exemplary example embodiment will be described with reference to FIG. 2. FIG. 2 is a flowchart illustrating a flow of the support method. An executing entity of each step in this support method may be a processor included in the information processing device 1, may be a processor included in another device, or executing entities of each of the steps may be processors provided in different devices.

In S1 (selection processing), at least one processor selects at least one persona based on at least one of a content of target content that is content to be checked, a creating entity, a presentation target, and an application.

In S2 (check processing), at least one processor checks the target content from the viewpoint of the persona selected in S1.

As described above, in the support method according to the present exemplary example embodiment, the configuration is adopted in which at least one processor executes the selection processing of selecting at least one persona based on at least one of the content of the target content that is the content to be checked, the creating entity, the presentation target, and the application, and the check processing of checking the target content from the viewpoint of the persona selected in the selection processing. According to this support method, an effect that the content can be checked from a reasonable viewpoint can be obtained.

### Second Exemplary Example Embodiment

A second exemplary example embodiment that is an example of the example embodiments of the present invention will be described in detail with reference to the drawings. Components having the same functions as the components described in the above-described exemplary example embodiment are denoted by the same reference signs, and the description thereof will be appropriately omitted. An application range of each technique adopted in the present exemplary example embodiment is not limited to the present exemplary example embodiment. That is, each technique adopted in the present exemplary example embodiment can also be adopted in other exemplary example embodiments included in the present disclosure within a range in which no particular technical problem occurs. Each technique illustrated in each of the drawings referred to for describing the present exemplary example embodiment can be adopted in other exemplary example embodiments included in the present disclosure within the scope in which no particular technical problem occurs.

### Configuration of Information Processing Device 1A

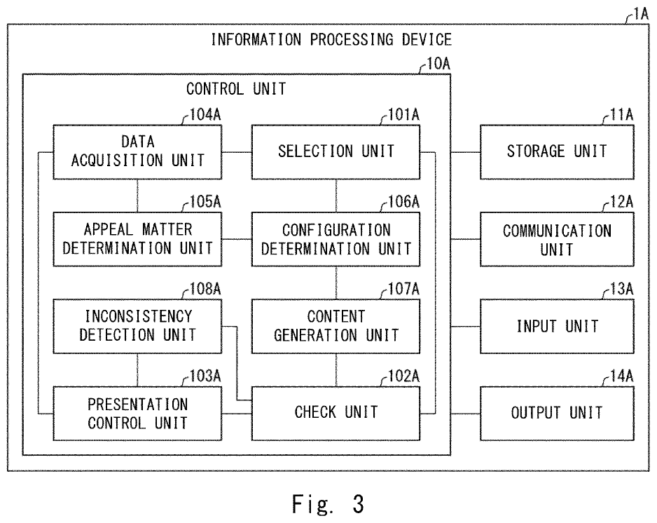

A configuration of an information processing device 1A according to the present exemplary example embodiment will be described with reference to FIG. 3. FIG. 3 is a block diagram illustrating the configuration of the information processing device 1A. The information processing device 1A is a device having a function of supporting creation of content. The information processing device 1A may be a local device (e.g., a device used by a content creator) used by individual users, or may be a server that provides a supporting service of content creation to a plurality of users.

As illustrated, the information processing device 1A includes a control unit 10A for integrally controlling each unit of the information processing device 1A, and a storage unit 11A for storing various types of data to be used by the information processing device 1A. The information processing device 1A includes a communication unit 12A for the information processing device 1A to communicate with another device, an input unit 13A for receiving an input to the information processing device 1A, and an output unit 14A for the information processing device 1A to output data. The control unit 10A includes a selection unit 101A, a check unit 102A, a presentation control unit 103A, a data acquisition unit 104A, an appeal matter determination unit 105A, a configuration determination unit 106A, a content generation unit 107A, and an inconsistency detection unit 108A.

Similarly to the selection unit 101 of the first exemplary example embodiment, the selection unit 101A selects at least one persona based on at least one of the content of the target content that is the content to be checked, the creating entity, the presentation target, and the application. Details on the method for selecting a persona will be described later.

Similarly to the check unit 102 of the first exemplary example embodiment, the check unit 102A checks the target content from the viewpoint of the persona selected by the selection unit 101A. Although details will be described later, an example of checking a target content using a language model generated by machine learning a natural language will be mainly described below.

Here, machine learning of a natural language more specifically means learning of the arrangement of constituent elements (words etc.) in a sentence of a natural language and the arrangement of a sentence and a sentence in a writing. Machine learning of a natural language generates a language model capable of performing natural language processing. Examples of the language model obtained by machine-learning the natural language include Bidirectional Encoder Representations from Transformers (BERT), Robustly optimized BERT approach (RoBERTa), Efficiently Learning an Encoder that Classifies Token Replacements Accurately (ELECTRA), and the like. Hereinafter, the language model used by the check unit 102A to check the target content is referred to as a language model 2A.

The presentation control unit 103A presents various types of information to the user of the information processing device 1A. An aspect of the presentation is not particularly limited. For example, the presentation control unit 103A may present the information to the user by causing a display device to display and output the information. Furthermore, for example, the presentation control unit 103A may cause a voice output device to output information by voice, or may cause a printing device to output information by printing. The device that causes information to be output may be included in the information processing device 1A or may be a device outside the information processing device 1A (e.g., a terminal device possessed by a target person of content creation support).

The data acquisition unit 104A acquires various types of information necessary for supporting creation of content. For example, material data indicating matters to be included in the target content is acquired. The material data may be input by the user or may be acquired from a database or the like outside the information processing device 1A. Furthermore, although details will be described later, the data acquisition unit 104A may acquire an answer of the user to a message presented to the user by the presentation control unit 103A as the material data.

Furthermore, the data acquisition unit 104A may acquire the related information of the target content by search. For example, the data acquisition unit 104A may perform a search using a word or the like included in the acquired material data as a keyword, and acquire information detected by the search as the related information. Furthermore, for example, the data acquisition unit 104A may acquire the related information using a method of Retrieval-Augmented Generation (RAG). In this case, the data acquisition unit 104A vectorizes a sentence or the like included in the material data, and searches for information related to the sentence or the like using the vector. The acquired related information can be used as material data of the target content. For example, it is also possible to acquire information supporting that the matter indicated in the acquired material data is the fact as related information and incorporate the information into the target content together with the above matter. As a result, the reliability of the target content can be improved.

The appeal matter determination unit 105A determines an appeal matter that is a matter to be appealed in the target content. For example, the appeal matter determination unit 105A may determine the appeal matter based on at least one of the content of the target content, the creating entity, the presentation target, and the application. In addition, the appeal matter determination unit 105A may determine the appeal matter based on the persona selected by the selection unit 101A.

The “appeal matter” can be rephrased as, for example, “claiming point” to be claimed in the target content, “main point” of the target content, and the like. Furthermore, determining the appeal matter “based on” the content or the like of the target content means directly or indirectly using the content or the like of the target content in the determination of the appeal matter. Details of the method for determining the appeal matter will be described later.

The configuration determination unit 106A determines the configuration of the target content. For example, the configuration determination unit 106A may determine the configuration based on at least one of the content of the target content, the creating entity, the presentation target, and the application. In addition, the configuration determination unit 106A may determine the configuration based on the persona selected by the selection unit 101A.

The “configuration of the target content” can also be rephrased as “arrangement of components in the target content”, “logical configuration of the target content”, “logical expansion of the target content”, “format of the target content”, “template of the target content”, or the like.

Furthermore, in a case where the target content is a proposal or the like, the configuration determination unit 106A may determine a flow of proposition in the proposal or the like. In addition, determining the configuration of the target content “based on” the content of the target content or the like means directly or indirectly using the content of the target content or the like in the determination of the configuration of the target content. Details of the method for determining the configuration will be described later.

The content generation unit 107A generates the target content. Although details will be described later, the content generation unit 107A uses the material data acquired by the data acquisition unit 104A and the determination result of the appeal matter determination unit 105A to generate the target content having the configuration determined by the configuration determination unit 106A.

As described above, the information processing device 1A includes the data acquisition unit 104A for acquiring material data and the content generation unit 107A for generating the target content using the acquired material data. As a result, in addition to the effect obtained by the information processing device 1, it is possible to automatically perform generation to check of the target content. This leads to a reduction in time and effort required to create the target content.

The inconsistency detection unit 108A detects an inconsistent portion in a check result from the viewpoints of a plurality of personas by the check unit 102A. “Inconsistent” can also be rephrased as “contradiction” or the like.

A method for detecting the inconsistent portion is not particularly limited. For example, the inconsistency detection unit 108A may detect an inconsistent portion using a language model generated by machine-learning a natural language such as the language model 2A. In this case, the inconsistency detection unit 108A generates a prompt including a check result from the viewpoints of a plurality of personas, the prompt instructing to detect an inconsistent portion of the check result, and inputs the generated prompt to the language model. As a result, the language model can be caused to output the inconsistent portion.

### Method for Selecting Persona

As described above, the selection unit 101A selects at least one persona based on at least one of the content of the target content that is the content to be checked, the creating entity, the presentation target, and the application.

The persona to be a selection candidate is defined in advance and recorded in the storage unit 11A or the like. Specifically, in addition to basic information such as age, gender, occupation, position, and affiliation (company or industry) of the persona, items that can affect the check result such as values, interests, determination criterion, and goals are defined for each persona. In addition, in a case where the persona is based on a real person, words and actions as well as judgement cases of the person, check items by the person, and the like may be included in the persona. For example, it is also possible to set a persona having common basic information but different determination criterion as a persona related to two superiors having the same position but different characters.

The persona may be selected based on, for example, a classification category. In this case, classification categories of the content may be defined in advance, and each classification category and the persona may be associated with each other in advance. In this case, the selection unit 101A may determine the category of the target content based on at least one of the content of the target content, the creating entity, the presentation target, and the application, and select the persona associated with the determined category.

As a specific example, a persona of “superior” and a persona of “client” may be associated with respect to a classification category of “proposal material to client” such as presentation material to be presented to a customer. On the other hand, the persona of “superior” and the persona of “colleague” may be associated with the classification category of “materials for internal use” such as internal examination materials and internal conference materials. In this case, in a case where the classification category determined from at least one of the content of the target content, the creating entity, the presentation target, and the application is “proposal material to client”, the selection unit 101A selects the persona of “superior” and the persona of “client”. On the other hand, in a case where the classification category of the target content is “internal conference material”, the selection unit 101A selects a persona of “superior” and a persona of “colleague”.

Furthermore, for example, the selection unit 101A may select a persona using a language model generated by machine-learning a natural language such as the language model 2A. In this case, the selection unit 101A generates a prompt instructing to select a persona, and inputs the generated prompt to the language model. As a result, information indicating the persona to be selected from the language model is output.

As a specific example, the selection unit 101A may generate the above prompt by using a template “The following content is used for the following applications: Please infer what kind of person should check this content and answer from the following candidates. [[Content] [Application] [Candidate] [Candidate] . . . ”. In this case, the selection unit 101A inputs information regarding the content of the target content to [Content] in the template, inputs information indicating the application of the target content to [Application], and inputs a sentence describing the persona selected by the selection unit 101A to [Candidate], thereby generating the prompt.

As the information regarding the content of the target content, for example, the material data acquired by the data acquisition unit 104A may be used, or the appeal matter determined by the appeal matter determination unit 105A may be used. Furthermore, material data acquired by the data acquisition unit 104A can be used as the information indicating the application of the target content. In addition, as the sentence describing the persona, all or some of the definitions of the persona recorded in advance can be used.

### Method for Checking Target Content

As described above, the check unit 102A checks the target content using the language model 2A. More specifically, the check unit 102A checks the target content by inputting, to the language model 2A, a prompt instructing to check the target content from the viewpoint of the persona selected by the selection unit 101A. As a result, in addition to the effect obtained by the information processing device 1, an effect is obtained in that the target content can be checked from the viewpoint of the persona selected by the selection unit 101A using the general-purpose language model 2A.

As a specific example, the check unit 102A may generate the above prompt by using a template “The following content will be used for the following applications. Please check this content from the viewpoint of the following checker and answer the check result. [[Content] [Application] [Checker] . . . ”. In this case, the check unit 102A inputs the target content to [Content] in the template, inputs information indicating the application of the target content to [Application], and inputs a sentence describing the persona selected by the selection unit 101A to [Checker], thereby generating the prompt.

In a case where the above prompt is used, the check unit 102A may use the answer sentence output from the language model 2A as it is as the check result. Furthermore, the check unit 102A may reconstruct the answer output from the language model 2A as necessary as the check result.

The language model 2A that has learned the determination criterion of the persona may be prepared for each persona. For example, by fine-tuning a general-purpose language model using a check case by the persona as training data, it is possible to generate the language model 2A capable of performing a check to which the determination criterion of the persona is applied.

In addition, for example, a check item may be defined in advance for each persona. In this case, the check unit 102A may determine whether the target content satisfies the check item related to the persona selected by the selection unit 101A. As a method for determining the sufficiency of a check item, a method related to the check item may be applied. For example, in the case of a check item regarding formal matters such as the number of characters and font, the sufficiency can be determined by analyzing the target content. Furthermore, for example, in the case of an abstract check item such as “whether the material appeals to the client's heart”, sufficiency can be determined by the language model 2A.

In addition, the check unit 102A may also perform a check on common check items regardless of the viewpoint of the persona. For example, the check unit 102A may also check whether internal information that should not be leaked is not included in the target content, whether there is a grammatical error, a mistaken character, or the like in the sentence, and the like.

### Method for Determining Appeal Matter

The appeal matter determination unit 105A determines an appeal matter that is a matter to be appealed in the target content. For example, the appeal matter determination unit 105A may determine the appeal matter using a language model generated by machine learning a natural language such as the language model 2A. In this case, the appeal matter determination unit 105A may generate a prompt including information (e.g., the material data described above) related to the content of the target content, the prompt instructing to infer the appeal matter related to the persona selected by the selection unit 101A in the target content specified by the information. Then, the appeal matter determination unit 105A may input the generated prompt to the language model. As a result, it is possible to cause the language model to output the appeal matter related to the persona.

As a specific example, the appeal matter determination unit 105A may generate the above prompt using a template “The content of the following content will be presented to the following target persons. Please infer what kind of matter should be appealed and answer the inference result. [Content] [Target persons]”. In this case, the appeal matter determination unit 105A generates the above prompt by inputting information regarding the content of the target content into [Content] in the template and inputting a sentence describing the persona selected by the selection unit 101A into [Target persons].

It is not essential to consider persona in determining an appeal matter. For example, the appeal matter determination unit 105A may determine the appeal matter based on at least one of the content of the target content, the creating entity, the presentation target, and the application. In addition, the user may determine the appeal matter. In this case, the configuration determination unit 106A sets the appeal matter determined by the user as the appeal matter of the target content.

### Method for Determining Configuration of Target Content

As described above, the configuration determination unit 106A determines the configuration of the target content. For example, in order to determine the configuration of the target content, a configuration suitable for the persona may be registered in advance for each persona that is a selection candidate of the selection unit 101A. In this case, the configuration determination unit 106A may determine the configuration related to the persona selected by the selection unit 101A among the configurations registered in advance as the configuration of the target content.

Furthermore, for example, the configuration determination unit 106A may determine the configuration using a language model generated by machine learning a natural language such as the language model 2A. In this case, the configuration determination unit 106A merely needs to generate a prompt including information regarding the content of the target content (e.g., the above-described material data and information indicating a matter determined as an appeal matter by the appeal matter determination unit 105A), the prompt instructing to infer the configuration related to the persona selected by the selection unit 101A to be applied to the target content specified by the information. Then, the configuration determination unit 106A may input the generated prompt to the language model. As a result, the language model can be caused to output a configuration related to the persona.

As a specific example, the configuration determination unit 106A may generate the above prompt by using a template “Present the content of the following content to the following target person. Please give a specific answer as to what the configuration of the content should be. [Content] [Target person]”. In this case, the configuration determination unit 106A inputs information regarding the content of the target content into [Content] in the template and inputs a sentence describing the persona selected by the selection unit 101A into [Target persons], thereby generating the prompt.

It is not essential to consider the persona in determining the configuration. For example, the configuration determination unit 106A may determine the configuration based on at least one of the content of the target content, the creating entity, the presentation target, and the application. In addition, the configuration of the target content may be designated by the user. In this case, the configuration determination unit 106A determines the configuration designated by the user as the configuration of the target content.

### Method for Generating Target Content

As described above, the content generation unit 107A uses the material data acquired by the data acquisition unit 104A and the determination result of the appeal matter determination unit 105A to generate the target content having the configuration determined by the configuration determination unit 106A.

For example, the content generation unit 107A may generate the target content by arranging the material data acquired by the data acquisition unit 104A and the appeal matter determined by the appeal matter determination unit 105A in such a way as to have the configuration determined by the configuration determination unit 106A. For example, in a case where the material data acquired by the data acquisition unit 104A can be a constituent element of the target content as it is and the configuration determined by the configuration determination unit 106A indicates the format of the target content, the target content can be generated by such simple processing.

Furthermore, for example, the content generation unit 107A may generate the target content using a generative model capable of generating the content. In this case, the content generation unit 107A generates a prompt including various types of information necessary for generating the content, inputs the prompt to the generative model, and causes the generative model to output the target content generated based on these pieces of information. By using the generative model, it is possible to flexibly generate higher-quality target content.

The generative model used for generating the target content may be a model generated for generating the content, or may be a general-purpose model that can be used for applications other than generation of the content. Furthermore, this generative model may be a model obtained by fine-tuning a general-purpose model for generating content. For example, a GPT model obtained by machine-learning a natural language, a BERT model obtained by machine-learning a natural language, or the like can also be used as this generative model. In a case where the target content to be generated is text data, the target content can be generated using a language model such as the language model 2A.

As a specific example, the content generation unit 107A may generate the above prompt by using a template “Please generate content in which the following elements are arranged in the following configuration. Appeal matter in the generated content is as follows. [Appeal matter] [Element] [Configuration]”. In this case, the content generation unit 107A inputs the appeal matter determined by the appeal matter determination unit 105A into [Appeal matter] in the template, inputs the constituent element of the target content such as the material data into [Element], and inputs the configuration determined by the configuration determination unit 106A into [Configuration], thereby generating the above prompt.

It is not essential to consider the appeal matter determined by the appeal matter determination unit 105A and the configuration determined by the configuration determination unit 106A in determining the configuration. For example, the content generation unit 107A can also generate the target content using only the material data acquired by the data acquisition unit 104A.

As described above, the information processing device 1A includes the appeal matter determination unit 105A for determining an appeal matter that is a matter to be appealed in the target content based on the persona selected by the selection unit 101A. Then, the content generation unit 107A generates the target content using the generative model capable of generating the content, the material data acquired by the data acquisition unit 104A, and the appeal matter determined by the appeal matter determination unit 105A. As a result, in addition to the effect achieved by the information processing device 1, an effect is obtained in that the appeal matter suitable for the persona can be automatically determined and the target content that conveys the appeal matter to the recipient can be automatically generated.

Furthermore, as described above, the information processing device 1A includes the configuration determination unit 106A for determining the configuration of the target content based on the persona selected by the selection unit 101A. Then, the content generation unit 107A generates the target content having the configuration determined by the configuration determination unit 106A. As a result, in addition to the effect obtained by the information processing device 1, an effect is obtained in that the target content having the configuration suitable for the persona selected by the selection unit 101A can be automatically generated. As a result, for example, it is possible to avoid a situation in which a matter to be appealed cannot be conveyed by the target content due to a configuration problem.

### Material Data Collection in Chat Format

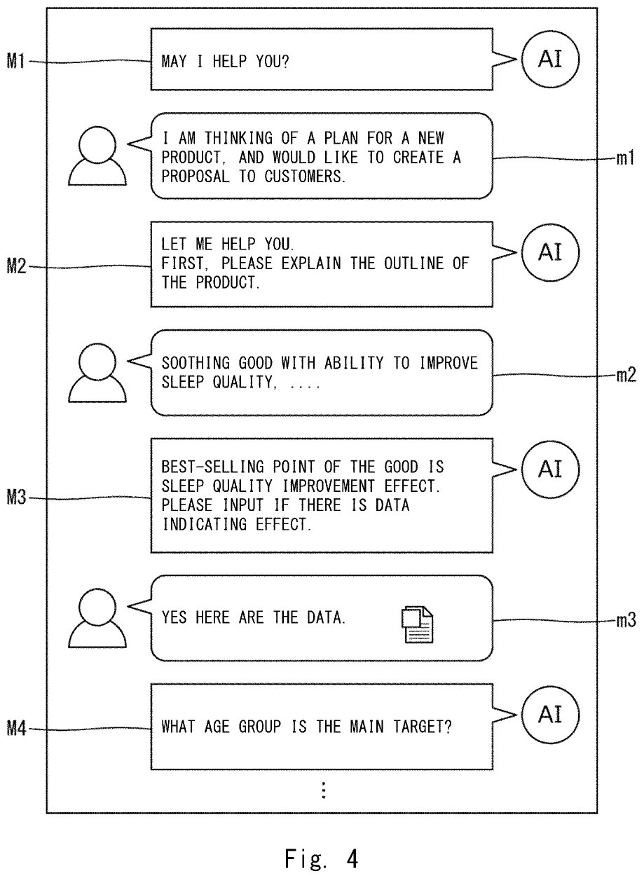

The information processing device 1A can also collect material data of the target content in a chat format. This will be described with reference to FIG. 4. FIG. 4 is a diagram illustrating a display screen example at the time of collecting material data of a target content in a chat format. Such a display screen is presented to the user (a person who intends to create the target content) by the presentation control unit 103A.

In the example of FIG. 4, messages exchanged in a chat format are displayed in chronological order. More specifically, the message on the information processing device 1A side is indicated by a balloon from an icon described as “AI”, and the message input by the user is indicated by a balloon from a human-shaped icon. In the following, a message on the information processing device 1A side will be described as a message from the AI.

In the example of FIG. 4, a message M1 prompting the user to input information on the target content desired to be created is displayed as the first message from the AI. The message to be presented first may be determined in advance, or may be generated by a language model such as the language model 2A. In the following description, it is assumed that the message of the AI is generated by the language model 2A. Then, as an answer to a message M1, a message m1 of the user to create a proposal for a new product is displayed.

Next, in the example of FIG. 4, a message M2 from the AI prompting the explanation of the outline of the product is displayed. The presentation control unit 103A can generate a message M2 having the content related to the message m1 by inputting the message m1 to the language model 2A.

Here, in generating the message M2, it is desirable that the presentation control unit 103A instructs the language model 2A to generate a message for asking out information necessary for generating the target content that the user desires to create. For example, the presentation control unit 103A may generate the prompt by inputting a message m1 to the portion of [Utterance] in the template of “You are an interviewer who gets out information necessary for generating content that the user wants to create. Please generate an answer to the following user's utterance. [Utterance]”. It is possible to generate an answer message such as the message M2 by inputting this prompt into the language model 2A.

Next, the answer of the user with respect to the message M2 is input to the information processing device 1A, and the answer is displayed as the message m2 of the user. Then, a new message based on the message m2 is generated by the language model 2A and displayed as a message M3 of the AI. The message M3 confirms the best-selling point, that is, the appeal matter of the content that the user desires to create. Such a message can also be said to be a message prompting input for the target content. In addition, the message M3 also includes contents prompting input of data related to the appeal matter. In this manner, the presentation control unit 103A may present a message prompting input of data other than text.

Next, the answer of the user with respect to the message M3 is input to the information processing device 1A, and the answer is displayed as the message m3 of the user. The message m3 indicates a positive answer to the message M3, that is, the fact that the matter presented in the message M3 is the user's appeal matter. The appeal matter determination unit 105A can also determine the appeal matter from the contents of such a dialogue (specifically, the messages M3 and m3). That is, the appeal matter determination unit 105A may determine the appeal matter based on the answer of the user with respect to the message related to the appeal matter presented by the presentation control unit 103A.

In addition, the message m3 includes data requested to be input in the message M3. In this manner, input of data may be accepted on the chat screen. The input data is acquired as material data by the data acquisition unit 104A. The data input accepting method is arbitrary, and it is not always necessary to accept the input via the chat screen.

Then, a new message based on the message m3 is generated by the language model 2A and displayed as a message M4 of the AI. The message M4 is a question asking a target layer of the product that the user wants to propose. Such a question message can also be said to be a message prompting input for the target content.

The messages M3 and M4 can also be generated in the same manner as the message M2. Hereinafter, similarly, message exchange is continued until information necessary for generating the target content is prepared. Then, the answer input by the user in this exchange is acquired as material data of the target content by the data acquisition unit 104A.

As described above, the information processing device 1A includes the presentation control unit 103A that presents the message prompting input for the target content. As described above, the data acquisition unit 104A acquires the answer input according to the message presented by the presentation control unit 103A as the material data. As a result, in addition to the effect obtained by the information processing device 1, an effect is obtained in that the user can be appropriately guided by the message and the material data necessary for generating the target content can be collected.

The message prompting input for the target content is more specifically a message prompting input of data indicating at least one of the content of the target content, the creating entity, the presentation target, and the application. As a result, it is possible to input material data necessary for generating the target content, and information useful for selection of persona, determination of an appeal matter, determination of a configuration, and the like. As described above, the answer acquired by the data acquisition unit 104A is not limited to text data such as a message.

Furthermore, as described above, the presentation control unit 103A may repeatedly perform processing of presenting a message prompting input of further information regarding the target content according to the answer with respect to the presented message. As a result, in addition to the effect obtained by the information processing device 1, an effect is obtained in that material data necessary for generating the target content can be collected without omission in the flow of the dialogue. As a result, it is also possible to generate the target content in which the intention of the user is sufficiently reflected.

### Presentation Example of Check Result

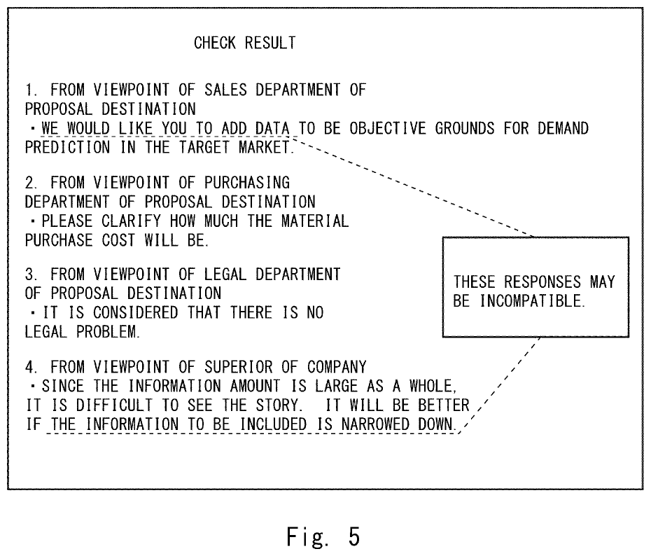

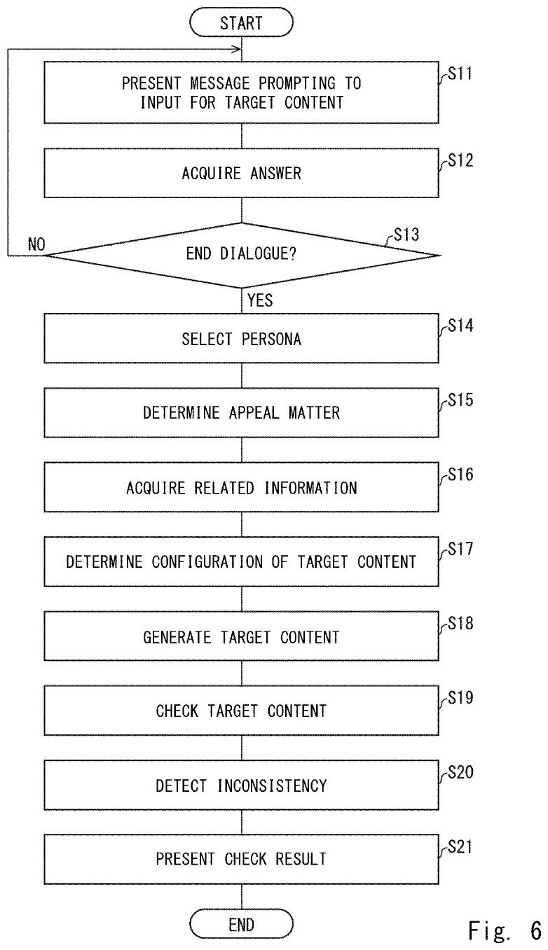

FIG. 5 is a diagram illustrating a display screen example of a check result. More specifically, the display screen example of FIG. 5 is a display screen example in a case where the selection unit 101A selects four personas of “sales department of proposal destination”, “purchasing department of proposal destination”, “legal department of proposal destination”, and “superior of company”, and the check unit 102A performs the check from the viewpoints of the four personas.

The check result from each viewpoint is generated by the language model 2A under the control of the check unit 102A, and the display screen as illustrated in FIG. 5 is presented by the presentation control unit 103A.

Here, in the display screen example of FIG. 5, the sentence “Add data” in the check result from the viewpoint of the persona of the “sales department of the proposal destination” and the sentence “Narrow-down information to be included” in the check result from the viewpoint of the persona of the “superior of the company” are underlined. Then, a comment indicating that these responses may be incompatible is displayed. These displays are based on the detection result of the inconsistency detection unit 108A.

As described above, the selection unit 101A may select a plurality of personas, and in a case where a plurality of personas are selected, the check unit 102A performs a check from the viewpoint of each persona. Then, the inconsistency detection unit 108A detects an inconsistent portion in the check result from the viewpoint of each persona, and the presentation control unit 103A presents the detected inconsistent portion. As a result, in addition to the effect obtained by the information processing device 1, an effect is obtained in that the user can be caused to recognize the inconsistent portion and the user can easily take an appropriate response to the inconsistent portion. For example, in the example of FIG. 5, the user can determine which of the check result from the viewpoint of the persona of the “sales department of the proposal destination” and the check result from the viewpoint of the persona of the “superior of the company” should be prioritized, and perform the correction work of the target content according to the determination result.

### Flow of Processing

A flow of processing executed by the information processing device 1A will be described with reference to FIG. 6. FIG. 6 is a flowchart illustrating a flow of processing executed by the information processing device 1A. The flowchart of FIG. 6 includes each processing of the support method according to the present exemplary example embodiment.

In S11, the presentation control unit 103A presents a message prompting to input for the target content. As a result, the dialogue with the user for collecting the material data is started.

In S12, the data acquisition unit 104A acquires an answer of the user with respect to the message presented in S11. The user's answer is acquired via the input unit 13A or the communication unit 12A. In the acquired answer, a content of the target content, a creating entity, a presentation target, an application, and the like are indicated, and a part or all of them are acquired as material data by the data acquisition unit 104A. The data acquisition unit 104A may acquire a part or all of the dialogue history as the material data after a series of dialogue ended.

In S13, the presentation control unit 103A determines whether to end the dialogue with the user. In a case where determination is made as YES in S13, the processing proceeds to S14. On the other hand, in a case where determination is made as NO in S13, the processing returns to S11. In S11 proceeded from S13, the presentation control unit 103A presents a message prompting input of further information for the target content according to the answer acquired in S12. As described above, the message to present can be generated by the language model 2A or the like.

The determination condition in S13 may be defined in advance. For example, the dialogue may be ended on condition that an input to end the dialogue is made from the user, or the dialogue may be ended on condition that material data necessary for generating the target content is prepared. In addition, material data of the target content may be input without depending on the dialogue. In this case, processing of accepting input of the material data is performed instead of S11 to S13.

In S14 (selection processing), the selection unit 101A selects at least one persona based on the answer acquired by the dialogue described above. In the answer acquired by the dialogue with the user, at least one of the content of the target content, the creating entity, the presentation target, and the application is indicated. Therefore, in S14, it can be said that the selection unit 101A selects the persona based on at least one of the content of the target content, the creating entity, the presentation target, and the application.

In S15, the appeal matter determination unit 105A determines the appeal matter in the target content. For example, the appeal matter determination unit 105A may determine the appeal matter by generating a prompt including the material data acquired by the above dialogue, the prompt instructing to infer the appeal matter according to the persona selected in S14, and inputting the generated prompt to the language model 2A.

In S16, the data acquisition unit 104A acquires the related information of the target content. Here, the data acquisition unit 104A may acquire the related information of the material data acquired by the dialogue described above, or may acquire the related information of the matter determined to be the appeal matter in S15. In a case where the related information for the appeal matter to be the main part of the target content is acquired, the target content in which the content of the main part is satisfactory can be generated.

In S17, the configuration determination unit 106A determines the configuration of the target content. For example, the configuration determination unit 106A may generate a prompt including the material data acquired by the above-described dialogue, the matter determined to be the appeal matter in S15, and the related information acquired in S16, the prompt instructing to infer the configuration to be applied to the target content generated based on these pieces of information and related to the persona selected in S14. Then, the configuration determination unit 106A may input the generated prompt to the language model and determine the configuration output by the language model 2A or the like as the configuration of the target content.

In S18, the content generation unit 107A generates the target content using the material data acquired by the above-described dialogue. For example, the content generation unit 107A may generate the target content by generating a prompt including the material data acquired by the above-described dialogue, the matter determined to be the appeal matter in S15, the related information acquired in S16, and the information indicating the configuration determined in S17, the prompt instructing to generate the content using these pieces of information, and inputting the generated prompt to the generative model.

In S19 (check processing), the check unit 102A checks the target content from the viewpoint of the persona selected in S14. For example, the check unit 102A may check the target content by generating a prompt including the target content generated in S18, the prompt instructing to check the target content from the viewpoint of the persona selected in S14, and inputting the generated prompt to the language model 2A.

In S20, the inconsistency detection unit 108A detects an inconsistent portion. For example, the inconsistency detection unit 108A may detect the inconsistent portion by generating a prompt including the check result of S19, the prompt instructing to detect the inconsistent portion of each check result, and inputting the generated prompt to the language model. In a case where the number of personas selected in S14 is one, the processing in S20 is omitted.

In S21, the presentation control unit 103A presents the result of the check in S19 to the user. Furthermore, in a case where an inconsistent portion is detected in S20, the presentation control unit 103A highlights and presents the inconsistent portion in the check result. Accordingly, the processing in FIG. 6 is ended.

### Application Example to Healthcare Application

The information processing device 1A can also be used for healthcare application. For example, the selection unit 101A may select personas of different doctors if a document summarizing the symptoms understood from the patient and various examination results is the target content. This makes it possible to obtain a check result of checking the condition of the patient from the viewpoint of a plurality of doctors.

### Modified Examples

An executing entity of each processing described in the above-described exemplary example embodiments is optional, and is not limited to the above-described examples. For example, a system having functions similar to those of the information processing devices 1 and 1A can be constructed by a plurality of devices capable of communicating with each other. The executing entity of each processing illustrated in the flowchart in FIG. 6 may be one device (may be rephrased as a processor) or a plurality of devices (may be similarly rephrased as processors).

### Implementation Example by Software

Some or all functions of the information processing devices 1 and 1A (hereinafter, also referred to as “each of the above devices”) may be implemented by hardware such as an integrated circuit (IC chip) or may be implemented by software.

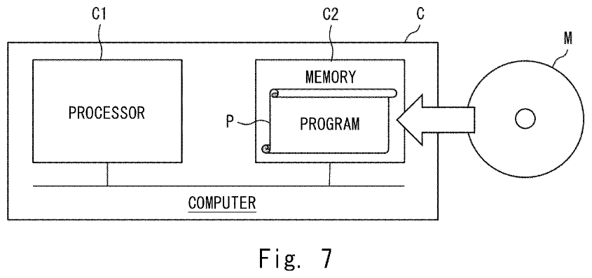

In the latter case, each of the above devices is achieved by, for example, a computer that executes commands of a program that is software for achieving each function. An example of such a computer (hereinafter, referred to as computer C) is illustrated in FIG. 7. FIG. 7 is a block diagram illustrating a hardware configuration of the computer C functioning as each of the above devices.

The computer C includes at least one processor C1 and at least one memory C2. A program (support program) P for causing the computer C to operate as each of the above devices is recorded in the memory C2. In the computer C, by the processor C1 reading the program P from the memory C2 and executing the program P, each function of each of the above devices is implemented.

As the processor C1, for example, a Central Processing Unit (CPU), a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, or a combination of these can be used. As the memory C2, for example, a flash memory, a Hard Disk Drive (HDD), a Solid State Drive (SSD), or a combination of these can be used.

The computer C may further include a Random Access Memory (RAM) for expanding the program P at the time of execution and temporarily storing various types of data. The computer C may further include a communication interface for transmitting and receiving data to and from another device. The computer C may further include an input/output interface for connecting input/output equipment such as a keyboard, a mouse, a display, or a printer.

The program P can be recorded on a non-transitory tangible recording medium M readable by the computer C. As such a recording medium M, for example, a tape, a disk, a card, a semiconductor memory, a programmable logic circuit, or the like can be used.

The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

Each of the above functions of each of the above devices may be achieved by a single processor provided in a single computer, may be achieved in cooperation with a plurality of processors provided in a single computer, or may be achieved in cooperation with a plurality of processors respectively provided in a plurality of computers. The program for causing each of the above devices to achieve each of the above functions may be stored in a single memory provided in a single computer, may be stored in a distributed manner in a plurality of memories provided in a single computer, or may be stored in a distributed manner in a plurality of memories respectively provided in a plurality of computers.

### Supplementary Information A

The present disclosure includes the techniques described in the following supplementary notes. However, the present invention is not limited to the techniques described in the following supplementary notes, and various modifications can be made within the scope described in the claims.

### Supplementary Note A1

An Information Processing Device Including
a selection means for selecting at least one persona based on at least one of a content of target content that is content to be checked, a creating entity, a presentation target, and an application, and
a check means for checking the target content from a viewpoint of the persona selected by the selection means.

### Supplementary Note A2

The information processing device according to supplementary note A1, in which the check means checks the target content by inputting a prompt instructing to check the target content from a viewpoint of the persona selected by the selection means to a language model generated by machine learning of a natural language.

### Supplementary Note A3

The information processing device according to supplementary note A1 or A2, further including
a data acquisition means for acquiring material data indicating a matter to be included in the target content, and
a content generation means for generating the target content by using the acquired material data.

### Supplementary Note A4

The information processing device according to supplementary note A3, further including a presentation control means for presenting a message prompting to input for the target content,
in which the data acquisition means acquires an answer input according to a message presented by the presentation control means as the material data.

### Supplementary Note A5

The information processing device according to supplementary note A4, in which the presentation control means repeatedly performs processing of presenting a message prompting input of further information on the target content according to an answer to the presented message.

### Supplementary Note A6

The information processing device according to any one of supplementary notes A3 to A5, further including an appeal matter determination means for determining an appeal matter that is a matter to be appealed in the target content based on the persona selected by the selection means,
in which the content generation means generates the target content using a generative model capable of generating content, the material data, and the appeal matter.

### Supplementary Note A7

The information processing device according to any one of supplementary notes A3 to A6, further including a configuration determination means for determining a configuration of the target content based on the persona selected by the selection means,
in which the content generation means generates the target content having the configuration determined by the configuration determination means.

### Supplementary Note A8

The information processing device according to any one of supplementary notes A1 to A7, in which
the selection means selects a plurality of personas, and
an inconsistency detection means for detecting an inconsistent portion in a check result from a viewpoint of each persona, and
a presentation control means for presenting the detected inconsistent portion are provided.

### Supplementary Information B

The present disclosure includes the techniques described in the following supplementary notes. However, the present invention is not limited to the techniques described in the following supplementary notes, and various modifications can be made within the scope described in the claims.

### Supplementary Note B1

A support method in which at least one processor executes
selection processing of selecting at least one persona based on at least one of a content of target content that is content to be checked, a creating entity, a presentation target, and an application, and
check processing of checking the target content from a viewpoint of the persona selected by the selection processing.

### Supplementary Note B2

The support method according to supplementary note B1, in which in the check processing, the at least one processor checks the target content by inputting a prompt instructing to check the target content from a viewpoint of the persona selected by the selection processing to a language model generated by machine learning a natural language.

### Supplementary Note B3

The support method according to supplementary note B1 or B2, further including
data acquisition processing in which the at least one processor acquires material data indicating a matter to be included in the target content, and
content generation processing in which the at least one processor generates the target content by using the acquired material data.

### Supplementary Note B4

The support method according to supplementary note B3, further including presentation control processing in which the at least one processor presents a message prompting to input for the target content,
in which in the data acquisition processing, the at least one processor acquires an answer input according to a message presented by the presentation control processing as the material data.

### Supplementary Note B5

The support method according to supplementary note B4, in which in the presentation control processing, the at least one processor repeatedly performs processing of presenting a message prompting input of further information on the target content according to an answer to the presented message.

### Supplementary Note B6

The support method according to any one of supplementary notes B3 to B5, further including appeal matter determination processing in which the at least one processor determines an appeal matter that is a matter to be appealed in the target content based on the persona selected in the selection processing,
in which in the content generation processing, the at least one processor generates the target content by using a generative model capable of generating content, the material data, and the appeal matter.

### Supplementary Note B7

The support method according to any one of supplementary notes B3 to B6, further including configuration determination processing in which the at least one processor determines a configuration of the target content based on the persona selected in the selection processing,
in which in the content generation processing, the at least one processor generates the target content having the configuration determined in the configuration determination processing.

### Supplementary Note B8

The support method according to any one of supplementary notes B1 to B7, in which
in the selection processing, the at least one processor selects a plurality of personas, and
inconsistency detection processing in which the at least one processor detects an inconsistent portion in a check result from a viewpoint of each persona, and
presentation control processing in which the at least one processor presents the detected inconsistent portion are provided.

### Supplementary Information C

The present disclosure includes the techniques described in the following supplementary notes. However, the present invention is not limited to the techniques described in the following supplementary notes, and various modifications can be made within the scope described in the claims.

### Supplementary Note C1

A support program for causing a computer to function as
a selection means for selecting at least one persona based on at least one of a content of a target content that is a content to be checked, a creating entity, a presentation target, and an application, and
a check means for checking the target content from a viewpoint of the persona selected by the selection means.

### Supplementary Note C2

The support program according to supplementary note C1, in which the check means checks the target content by inputting a prompt instructing to check the target content from a viewpoint of the persona selected by the selection means to a language model generated by machine learning of a natural language.

### Supplementary Note C3

The support program according to supplementary note C1 or C2, further causing the computer to function as
a data acquisition means for acquiring material data indicating a matter to be included in the target content, and
content generation means for generating the target content by using the acquired material data.

### Supplementary Note C4

The support program according to supplementary note C3, further causing the computer to function as a presentation control means for presenting a message prompting to input for the target content,
in which the data acquisition means acquires an answer input according to a message presented by the presentation control means as the material data.

### Supplementary Note C5

The support program according to supplementary note C4, in which the presentation control means repeats processing of presenting a message prompting input of further information on the target content according to an answer to the presented message.

### Supplementary Note C6

The support program according to any one of supplementary notes C3 to C5, further causing the computer to function as an appeal matter determination means for determining an appeal matter that is a matter to be appealed in the target content based on the persona selected by the selection means,
in which the content generation means generates the target content using a generative model capable of generating content, the material data, and the appeal matter.

### Supplementary Note C7

The support program according to any one of supplementary notes C3 to C6, further causing the computer to function as a configuration determination means for determining a configuration of the target content based on the persona selected by the selection means,
in which the content generation means generates the target content having the configuration determined by the configuration determination means.

### Supplementary Note C8

The support program according to any one of supplementary notes C1 to C7, in which
the selection means selects a plurality of personas, and
the computer is caused to function as
an inconsistency detection means for detecting an inconsistent portion in a check result from a viewpoint of each persona, and
a presentation control means for presenting the detected inconsistent portion.

### Supplementary Information D

The present disclosure includes the techniques described in the following supplementary notes. However, the present invention is not limited to the techniques described in the following supplementary notes, and various modifications can be made within the scope described in the claims.

### Supplementary Note D1

An information processing device including at least one processor, in which the at least one processor executes
selection processing of selecting at least one persona based on at least one of a content of target content that is content to be checked, a creating entity, a presentation target, and an application, and
check processing of checking the target content from a viewpoint of the persona selected by the selection processing.

The information processing device may further include a memory. The memory may store a program for causing the at least one processor to execute each processing.

### Supplementary Note D2

The information processing device according to supplementary note D1, in which in the check processing, the at least one processor checks the target content by inputting a prompt instructing to check the target content from a viewpoint of the persona selected by the selection processing to a language model generated by machine learning a natural language.

### Supplementary Note D3

The information processing device according to supplementary note D1 or D2, in which the at least one processor executes
data acquisition processing of acquiring material data indicating a matter to be included in the target content, and
content generation processing of generating the target content by using the acquired material data.

### Supplementary Note D4

The information processing device according to supplementary note D3, in which
the at least one processor executes presentation control processing of presenting a message prompting to input for the target content, and
in the data acquisition processing, the at least one processor acquires an answer input according to a message presented by the presentation control processing as the material data.

### Supplementary Note D5

The information processing device according to supplementary note D4, in which in the presentation control processing, the at least one processor repeatedly performs processing of presenting a message prompting input of further information on the target content according to an answer to the presented message.

### Supplementary Note D6

The information processing device according to any one of supplementary notes D3 to D5, in which
the at least one processor executes appeal matter determination processing of determining an appeal matter that is a matter to be appealed in the target content based on the persona selected in the selection processing, and
in the content generation processing, the at least one processor generates the target content by using a generative model capable of generating content, the material data, and the appeal matter.

### Supplementary Note D7

The information processing device according to any one of supplementary notes D3 to D6, in which
the at least one processor executes configuration determination processing of determining a configuration of the target content based on the persona selected in the selection processing, and
in the content generation processing, the at least one processor generates the target content having the configuration determined in the configuration determination processing.

### Supplementary Note D8

The information processing device according to any one of supplementary notes D1 to D7, in which
in the selection processing, the at least one processor selects a plurality of personas, and executes
inconsistency detection processing of detecting an inconsistent portion in a check result from a viewpoint of each persona, and
presentation control processing of presenting the detected inconsistent portion.

### Supplementary Information E

The present disclosure includes the techniques described in the following supplementary notes. However, the present invention is not limited to the techniques described in the following supplementary notes, and various modifications can be made within the scope described in the claims.

### Supplementary Note E1

A non-transitory recording medium recorded with an information processing program for causing a computer to function as an information processing device, in which the program causes the computer to execute
selection processing of selecting at least one persona based on at least one of a content of target content that is content to be checked, a creating entity, a presentation target, and an application, and
check processing of checking the target content from a viewpoint of the persona selected by the selection processing.

1. An information processing apparatus including at least one of memory may store a program for causing the at least one processor to executes
selection processing of selecting at least one persona based on at least one of a content of target content that is content to be checked, a creating entity, a presentation target, and an application, and
check processing of checking the target content from a viewpoint of the persona selected by the selection processing.

2. The information processing apparatus according to claim 1, in which in the check processing, the at least one processor checks the target content by inputting a prompt instructing to check the target content from a viewpoint of the persona selected by the selection processing to a language model generated by machine learning a natural language.

3. The information processing apparatus according to claim 1, in which the at least one processor executes
data acquisition processing of acquiring material data indicating a matter to be included in the target content, and
content generation processing of generating the target content by using the acquired material data.

4. The information processing apparatus according to claim 3, in which
the at least one processor executes presentation control processing of presenting a message prompting to input for the target content, and
in the data acquisition processing, the at least one processor acquires an answer input according to a message presented by the presentation control processing as the material data.

5. The information processing apparatus according to claim 4, in which in the presentation control processing, the at least one processor repeatedly performs processing of presenting a message prompting input of further information on the target content according to an answer to the presented message.

6. The information processing apparatus according to claim 3, in which
the at least one processor executes appeal matter determination processing of determining an appeal matter that is a matter to be appealed in the target content based on the persona selected in the selection processing, and
in the content generation processing, the at least one processor generates the target content by using a generative model capable of generating content, the material data, and the appeal matter.

7. The information processing apparatus according to claim 3, in which
the at least one processor executes configuration determination processing of determining a configuration of the target content based on the persona selected in the selection processing, and
in the content generation processing, the at least one processor generates the target content having the configuration determined in the configuration determination processing.

8. The information processing apparatus according to claim 1, in which
in the selection processing, the at least one processor selects a plurality of personas, and executes
inconsistency detection processing of detecting an inconsistent portion in a check result from a viewpoint of each persona, and
presentation control processing of presenting the detected inconsistent portion.

9. A support method in which at least one processor executes
selection processing of selecting at least one persona based on at least one of a content of target content that is content to be checked, a creating entity, a presentation target, and an application, and
check processing of checking the target content from a viewpoint of the persona selected by the selection processing.

10. The support method according to claim 9, in which in the check processing, the at least one processor checks the target content by inputting a prompt instructing to check the target content from a viewpoint of the persona selected by the selection processing to a language model generated by machine learning a natural language.

11. The support method according to claim 9, further including
data acquisition processing in which the at least one processor acquires material data indicating a matter to be included in the target content, and
content generation processing in which the at least one processor generates the target content by using the acquired material data.

12. The support method according to claim 11, further including presentation control processing in which the at least one processor presents a message prompting to input for the target content,
in which in the data acquisition processing, the at least one processor acquires an answer input according to a message presented by the presentation control processing as the material data.

13. The support method according to claim 11, further including appeal matter determination processing in which the at least one processor determines an appeal matter that is a matter to be appealed in the target content based on the persona selected in the selection processing,
in which in the content generation processing, the at least one processor generates the target content by using a generative model capable of generating content, the material data, and the appeal matter.

14. The support method according to claim 11, further including configuration determination processing in which the at least one processor determines a configuration of the target content based on the persona selected in the selection processing,
in which in the content generation processing, the at least one processor generates the target content having the configuration determined in the configuration determination processing.

15. The support method according to claim 9, in which
in the selection processing, the at least one processor selects a plurality of personas, and
inconsistency detection processing in which the at least one processor detects an inconsistent portion in a check result from a viewpoint of each persona, and
presentation control processing in which the at least one processor presents the detected inconsistent portion are provided.

16. The non-transitory recording medium recorded with an information processing program for causing a computer to function as an information processing apparatus, in which the program causes the computer to execute
selection processing of selecting at least one persona based on at least one of a content of target content that is content to be checked, a creating entity, a presentation target, and an application, and
check processing of checking the target content from a viewpoint of the persona selected by the selection processing.

17. The non-transitory recording medium recorded with an information processing program for causing a computer to function as an information processing apparatus according claim 16, in which in the check processing, the at least one processor checks the target content by inputting a prompt instructing to check the target content from a viewpoint of the persona selected by the selection processing to a language model generated by machine learning a natural language.

18. The non-transitory recording medium recorded with an information processing program for causing a computer to function as an information processing apparatus according claim 16 further including;
data acquisition processing in which the at least one processor acquires material data indicating a matter to be included in the target content, and
content generation processing in which the at least one processor generates the target content by using the acquired material data.

19. The non-transitory recording medium recorded with an information processing program for causing a computer to function as an information processing apparatus according claim 16 in which;
in the selection processing, the at least one processor selects a plurality of personas, and
inconsistency detection processing in which the at least one processor detects an inconsistent portion in a check result from a viewpoint of each persona, and
presentation control processing in which the at least one processor presents the detected inconsistent portion are provided.
